(19) United States
(12) Patent Application Publication
(10) Pub. No.: US 2013/0300367 A1
(43) Pub. Date: Nov. 14, 2013

(54) Rechargeable Power Supply Device

(71) Applicant: Robert Steven Yates, New York, NY (US)

(72) Inventor: Robert Steven Yates, New York, NY (US)

(21) Appl. No.: 13/468,409

(22) Filed: May 10, 2012

(51) Int. Cl. H02J 7/04

(52) U.S. Cl. 320/111

(57) ABSTRACT

A portable, rechargeable lithium battery power supply device that can power home electronics or home lights or appliances is disclosed in the present invention. Said device comprises a lithium ion battery, an AC/DC inverter, a diode, a charger and a outlet. Said device provides 120 volt direct current power to home electronics or home light or appliances.

### BACKGROUND OF THE INVENTION

### Field of the Invention

The present invention relates to a portable, rechargeable power supply device. More particularly, the present invention relates to a portable, rechargeable lithium ion battery power supply device that provides 120 volt direct current power to home electronics, home lights or appliances.

There is a continual demand for high energy use by public. Most often, both low power device, such as home electronics, lights or appliances, and high power devices, such a s air conditioners, heavy duty refrigerators or washing machines, are connected to public utility power network. It is desirable to have a power supply device to provide electricity for home low power devices and only have the high power connected to the public utility power network. This allows the public to break away from the need to use the electrical current for short periods while saving power, giving the electrical grid more power for public use.

### SUMMARY OF THE INVENTION

In an exemplary embodiment of the present invention, there is disclosed a portable, rechargeable power supply device. More particularly, the present invention relates to a portable, rechargeable lithium ion battery power supply device that provides 120 volt direct current power to home electronics, home lights or appliances. Said device includes a lithium battery as power source to provide electricity, an AC/DC inverter to turn the AC (alternating current) into DC (direct current) to power the electronics being used, a diode to control the flow of the current in one way, a charger to charge the batteries that are connected to the devices and also to recharge the device when all batteries are fully dead. Said device can supply 120 volt DC power for a certain amount of time.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an illustration of the components of one embodiment of the present invention.

FIG. 2 is an illustration of a heavy duty model of the present invention.

### DESCRIPTION OF THE PREFERRED EMBODIMENT

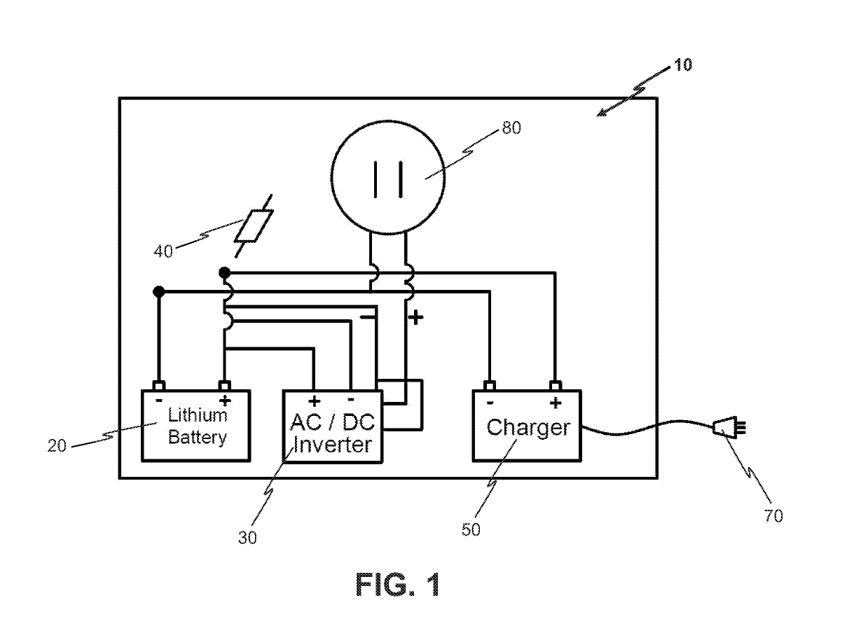

Referring to FIG. 1, there is disclosed, there is disclosed a portable, rechargeable power supply device. More particularly, the present invention relates to a portable, rechargeable lithium ion battery power supply device that provides 120 volt direct current power to home electronics, home lights or appliances. As illustrated in FIG. 1, said device 10 is comprised of a lithium battery 20, which is used to supply the power for the whole system; an AC/DC inverter 30 to transform the 12 volt power into 120 volt DC power; a one way diode 40 to control the flow of current only in on direction in order to control power surges and over charging; a charger 50 to charge the batteries that are connected to the said devices and also to recharge the said device when all batteries are fully dead, a outlet 60 in which home electronics and appliances can be plugged. Said device can be connected to standard 120 volt public power utility network through standard plug 70 for fully charging the said lithium batteries.

In one embodiment of the present invention, said lithium battery is a heavy duty lithium ion battery made by Braille Battery and used in the highest level of motorsport, Formula 1 racing. In another embodiment of the present invention, one above lithium ion battery is used to make a low voltage model which can handle lights, small TVs, laptops, video games and etc.

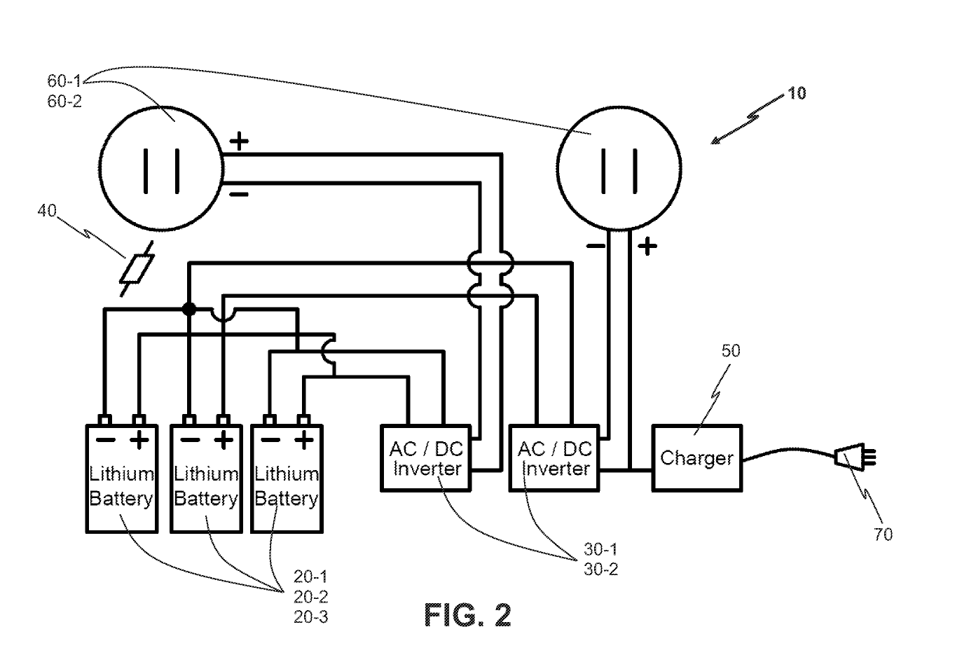

In another embodiment of the present invention, as illustrated in FIG. 2, a heavy duty model of said device in which more lithium batteries, or more low voltage model units can be used to supply more power. In another embodiment of the present invention, said heavy duty model 10 includes three (3) lithium batteries 20-1, 20-2, 20-3; more inverters 30-1, 30-2 and more outlets 60-1, 60-2.

In another embodiment of the present invention, said charger is a slow Amp charger, fully automatic and connected to lithium batteries with one way diodes to the inverters.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A portable, rechargeable lithium battery power supply device, comprising:
a lithium battery;
an AC/DC inverter to transform 12 volt power into 120 volt DC power;
a one way diode to control the flow of current only in one direction;
a charger to charge batteries connected to said device or to recharge said lithium battery; and
an outlet in which home electronics and appliances can be plugged.

2. A portable, rechargeable lithium battery power supply device of claim 1, wherein said lithium is an automobile lithium ion battery used in high level of motorsport or Formula 1 racing.

3. A portable, rechargeable lithium battery power supply device of claim 1, wherein said charger is a 120 volt slow Amp charger.
